(19) United States
(12) Patent Application Publication
(10) Pub. No.: US 2019/0156428 A1
(43) Pub. Date: May 23, 2019

(54) TRANSACTION RECONCILIATION SYSTEM

(71) Applicant: Accenture Global Solutions Limited, Dublin (IE)

(72) Inventors: Prakash Ghatage, Bangalore (IN); Nirav Sampat, Mumbai (IN); Kumar Viswanathan, San Jose, CA (US); Sebastian Fernandes, Bangalore (IN); Naveen Kumar Thangaraj, Ammapet (IN)

(21) Appl. No.: 15/818,309

(22) Filed: Nov. 20, 2017

(51) Int. Cl. G06Q 40/00; G06F 17/30; G06F 17/27

(52) U.S. Cl. CPC G06Q 40/12; G06F 17/2785; G06F 17/2765; G06F 17/30011

(57) ABSTRACT

A system for reconciling transactions includes an interface, a processor and non-transitory computer readable media. The interface receives information related to a plurality of organizations. Each of the plurality of organizations includes an enterprise resource planning (ERP) system for maintaining account information associated with the organization, and a document management system (DMS) for maintaining documents for the organization. The non-transitory computer readable media is in communication with the processor. The non-transitory computer readable media that stores instruction code that causes the processor to determine, based on the information, a group of organizations of the plurality of organizations that are structurally related to one another. For each group of organizations, the processor a) communicates a request to an associated enterprise planning system for information related to an account to thereby obtain an account balance for the organization, b) communicates a request to an associated DMS for documents, c) performs natural language processing techniques on the documents to thereby determine support documents that support transactions related to the account, and d) accumulates transaction amounts specified in the support documents. When a sum of the transaction amounts is within a predetermined threshold of the account balance, the processor determines the account to be reconciled and generates a report that specifies the account balance and the support documents.

### BACKGROUND

### Field

This application generally relates to enterprise management systems. In particular, this application describes a transaction reconciliation system.

### Description of Related Art

Companies typically perform financial period end close activities on a monthly and/or quarterly basis. These activities are sometimes referred to as settlement or reconciliation. During settlement, various reports may be generated by a company's enterprise resource planning (ERP) system related to account balances. In particular, the ERP system may maintain a general ledger for the company that includes various transaction entries related to income and expenses incurred by the company. At the end of a financial cycle, an auditor may request a listing of transactions along with the current balance of the general ledger from ERP system. The ERP system may provide a document such as a spreadsheet with the requested information.

Settlement of a single organization is a relatively time consuming process. In large organizational structures, there may be a large number of subsidiary companies or jointly owned companies each having their own ERP system to manage a general ledger. Thus, settlement procedures in such organizational structures are exacerbated.

### BRIEF SUMMARY

In one aspect, a system for reconciling transactions includes an interface, a processor and non-transitory computer readable media. The interface receives information related to a plurality of organizations. Each of the plurality of organizations includes an enterprise resource planning (ERP) system for maintaining account information associated with the organization, and a document management system (DMS) for maintaining documents for the organization. The non-transitory computer readable media is in communication with the processor. The non-transitory computer readable media that stores instruction code that causes the processor to determine, based on the information, a group of organizations of the plurality of organizations that are structurally related to one another. For each group of organizations, the processor a) communicates a request to an associated enterprise planning system for information related to an account to thereby obtain an account balance for the organization, b) communicates a request to an associated DMS for documents, c) performs natural language processing techniques on the documents to thereby determine support documents that support transactions related to the account, and d) accumulates transaction amounts specified in the support documents. When a sum of the transaction amounts is within a predetermined threshold of the account balance, the processor determines the account to be reconciled and generates a report that specifies the account balance and the support documents.

In a second aspect, a method for reconciling transactions includes receiving information related to a plurality of organizations. Each of the plurality of organizations includes an enterprise resource planning (ERP) system for maintaining account information associated with the organization, and a document management system (DMS) for maintaining documents for the organization. The method also includes determining, based on the information, a group of organizations of the plurality of organizations that are structurally related to one another. For each group of organizations, the method includes a) communicating a request to an associated enterprise planning system for information related to an account to thereby obtain an account balance for the organization, b) communicating a request to an associated DMS for documents, c) performing natural language processing techniques on the documents to thereby determine support documents that support transactions related to the account, and d) accumulating transaction amounts specified in the support documents. When a sum of the transaction amounts is within a predetermined threshold of the account balance, the method includes determining the account to be reconciled and generating a report that specifies the account balance and the support documents.

In a third aspect, a non-transitory computer readable media that stores instruction code for reconciling transactions. The instruction code is executable by a machine and causes the machine to perform acts including receiving information related to a plurality of organizations. Each of the plurality of organizations includes an enterprise resource planning (ERP) system for maintaining account information associated with the organization, and a document management system (DMS) for maintaining documents for the organization. The instruction also causes the machine to determine, based on the information, a group of organizations of the plurality of organizations that are structurally related to one another. For each group of organizations, the instruction code causes the machine to a) communicate a request to an associated enterprise planning system for information related to an account to thereby obtain an account balance for the organization, b) communicate a request to an associated DMS for documents, c) perform natural language processing techniques on the documents to thereby determine support documents that support transactions related to the account, and d) accumulate transaction amounts specified in the support documents. When a sum of the transaction amounts is within a predetermined threshold of the account balance, the instruction code causes the machine to determine the account to be reconciled, and generates a report that specifies the account balance and the support documents.

### BRIEF DESCRIPTION OF THE DRAWINGS

FIG. 1 illustrates an exemplary environment that includes various systems/devices that facilitate settling accounts of organizations having large organizational structures;

FIG. 2 illustrates exemplary details of the systems associated with the related organization of the environment;

FIG. 3 illustrates exemplary operations performed by one or more of the subsystems of a settlement system of the environment in configuring the settlement system to perform settlement operations;

FIG. 4 illustrates an exemplary checklist management webpage that may be communicated to an administrative terminal;

FIG. 5 illustrates an exemplary group code mapping webpage that may be communicated to the administrative terminal;

FIG. 6 illustrates an exemplary task management webpage that may be communicated to the administrative terminal 106;

FIG. 7 illustrates an interface that may be generated to facilitate entering the task information;

FIG. 8 illustrates various operations performed by the settlement system when executing a task;

FIG. 9 illustrates an exemplary general ledger interface that may be generated by the settlement system to convey general ledger transaction information associated with structurally related companies;

FIG. 10 illustrates an exemplary joint venture account interface that may be generated by the settlement system to convey joint venture account information associated with structurally related companies;

FIG. 11 illustrates an exemplary settlement interface that facilitates providing support documents to support transactions associated with the general ledger and joint venture accounts;

FIG. 12 illustrates an exemplary report that may be communicated to the reviewers; and

FIG. 13 illustrates an exemplary computer system that may form part of or implement the systems described in the figures or in the following paragraphs.

### DETAILED DESCRIPTION

The embodiments described below overcome the problems described in the background by providing a system that speeds up financial period end close activities, reduces errors, and other problems caused by information errors and/or incompatibilities among devices/systems involved in the transaction processing. As a result, the system uses less power and computational resources than disparate systems because redundancies present in those disparate systems are eliminated.

In operation, the system receives account information from ERP systems of various structurally related organizations. The system then searches for documents for evidence that supports transactions related to the accounts. The system continues this process until enough documentary evidence has been found to support the balance of the accounts. Afterwards, the system generates a report which is reviewed by a reviewer. The system automatically begins these operations according to a fiscal period.

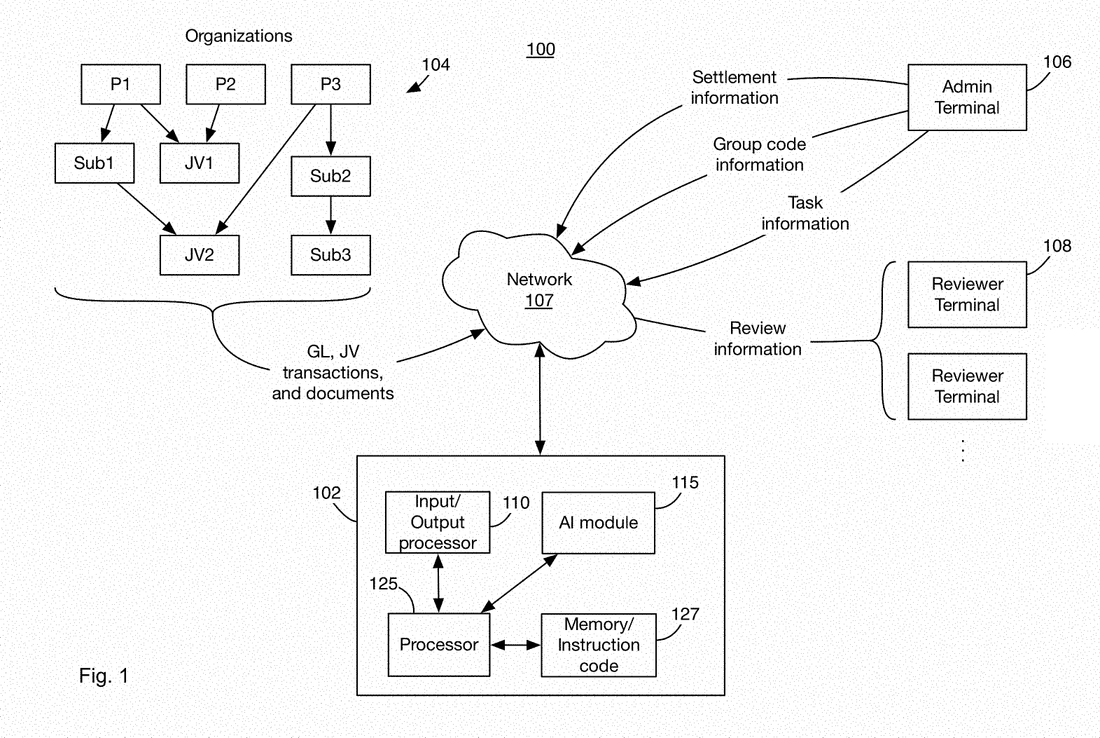

FIG. 1 illustrates an exemplary environment 100 that includes various systems/devices that facilitate settling accounts of organizations having large organizational structures. The systems/devices may be owned, jointly owned and/or operated by organizations, such as corporations, government agencies, institutions, individuals, etc.

Exemplary systems/devices of the environment 100 include a settlement system 102, an exemplary group of systems 104 associated with related organizations, an administrative terminal 106, and a reviewer terminal(s) 108. The settlement system 102, systems 104 associated with related organizations, administrative terminal 106, and reviewer terminal(s) 108 may communicate with one another via a network 107, such as the Internet.

The administrative terminal 106 and reviewer terminal(s) 108 may correspond to computer systems such as an Intel®, AMD®, or PowerPC® based computer system or a different computer system and can include application specific computer systems. The computer systems may include an operating system, such as Microsoft Windows®, Linux, Unix® or other operating system. The terminals may be desktop PCs and/or mobile terminals.

The administrative terminal 106 may be operated by a user/individual tasked with configuring the settlement system 102 to initiate various settlement-related operations. In this regard, the administrative terminal 106 may be configured to facilitate communicating information with the settlement system 102 via one or more APIs of the settlement system 102. For example, the administrative terminal 106 may be configured to communicate with the settlement system 102 via an API such as a webserver API, a SOAP-based web service, a RESTful API, and/or a different type of API.

Likewise, the reviewer terminal(s) 108 may be operated by a user/individual tasked with reviewing settlement reports generated by the settlement system 102. In this regard, the reviewer terminal(s) 108 may be configured to facilitate communicating information with the settlement system 102 via one or more APIs of the settlement system 102. For example, the administrative terminal 106 may be configured to communicate with the settlement system 102 via an API such as a webserver API, a SOAP-based web service, a RESTful API, and/or a different type of API.

The related organizations may correspond to a group of companies that are related to one another. For example, the group may include parent companies P1, P2, and P3. As indicated by the arrows connecting the systems 104, company Sub1 may be a subsidiary of parent company P1. Company JV1 may be jointly owned by parent companies P1 and P2. Company JV2 may be jointly owned by subsidiary company Sub 1 and parent company P3. Company Sub3 may be a subsidiary of Company Sub 2, which is a subsidiary of company P3.

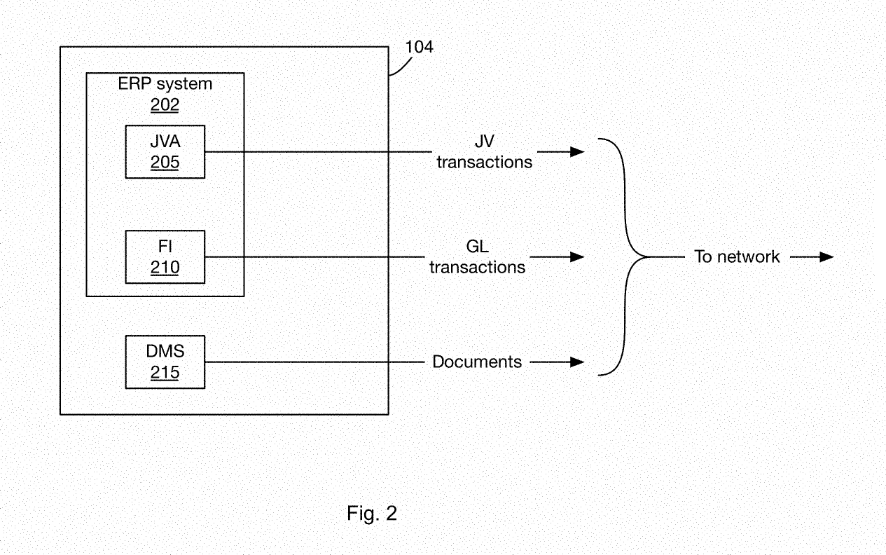

FIG. 2 illustrates exemplary details of the systems 104 associated with the related organization. Referring to FIG. 2, each system 104 may include an enterprise resource planning (ERP) subsystem 202 that facilitates tracking business resources such as cash, raw materials, production capacity, the status of business commitments (e.g., orders, purchase orders), and payroll. Each system 104 may also include a document management system (DMS) 215. Other business resources may be tracked.

The respective subsystems 202 and 215 may implement APIs that facilitate receiving a query for information stored by the respective subsystem. For example, the query may specify the types of information to retrieve, a document/transaction creation date range associated with creation of the information, the author associated with a document, etc.

In one exemplary environment, ERP subsystem 202 system may correspond to an SAP ERP system. In this regard, the ERP subsystem 202 may include various modules that facilitate tracking business resources. For example, the ERP subsystem 202 may include an FI module 210 and a JVA module 205. The FI module 210 is configured among other things to maintain a general ledger (GL) of financial transactions for the company. The FI module 210 facilitates managing data involved in any financial and business transactions in a unified system. The JVA module 205 is configured to maintain one or more joint venture accounts (JVAs) of expenditures and other joint venture transactions associated with one or more joint ventures. The JVA module 205 interacts with other modules of the ERP subsystem 202 to facilitate performance of these functions.

The DMS subsystem 215 tracks, manages and stores documents associated with the corresponding company. The DMS subsystem 215 may track various versions of documents created and modified by different users.

Referring back to FIG. 1, the settlement system 102 receives account transactions from the systems 104 associated with related organizations to facilitate reconciliation/settlement of the accounts. To facilitate performing these operations, the settlement system 102 incudes a processor 125, input/output subsystem 110, and an AI subsystem 115. The settlement system 102 may include other subsystems.

The I/O processor 110 of the settlement system 102 is configured to facilitate communications with entities outside of the settlement system 102. In this regard, the I/O processor 110 may be configured to dynamically determine the communication methodology utilized by entities of the environment 100 for communicating information to the entities using the determined communication methodology. For example, the I/O processor 110 may determine that a first entity utilizes a RESTful API and may, therefore, communicate with the entity using a RESTful communication methodology.

As described in more detail below, the I/O processor 110 may implement a web browser to facilitate generating one or more web-based interfaces through which users may interact with the settlement system 102. The web browser may implement a web services interface to facilitate automating some of the web-based functionality via a computer. For example, one or more of the entities of the environment may utilize the web services interfaces to control aspects and/or interact with the settlement system 102.

The AI subsystem 115 module is configured to locate documentation in the DMS subsystem 215 that provides support for transactions received from the ERP subsystem 202. In this regard, the AI subsystem 115 may utilize various natural language processing techniques to locate documentation that may relate to a given transaction. For example, the language processing may perform a Knuth-Morris-Pratt string searching algorithm to locate and extract occurrences of a certain words within a document. Linear clustering algorithms may be utilized to mine text data based on group codes (described below) that are associated GL and JVA accounts.

The processor 125 executes instruction code stored in a memory device 127 for coordinating activities performed between the various subsystems. The processor 125 may correspond to a stand-alone computer system such as an Intel®, AMD®, or PowerPC® based computer system or a different computer system and can include application specific computer systems. The computer systems may include an operating system, such as Microsoft Windows®, Linux, Unix® or other operating system.

It is contemplated that the I/O processor 110, AI subsystem 115, and any other subsystem referenced herein may correspond to a stand-alone computer system such as an Intel®, AMD®, or PowerPC® based computer system or a different computer system and can include application specific computer systems. The computer systems may include an operating system, such as Microsoft Windows®, Linux, Unix® or other operating system. It is also contemplated that operations performed on the various subsystems may be combined into a fewer or greater number of subsystems to facilitate speed scaling, cost reductions, etc.

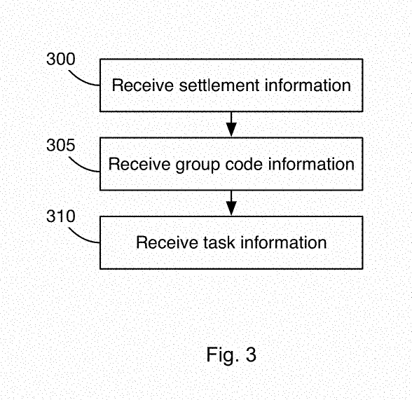

Exemplary operations performed by one or more of the subsystems of the settlement system 102 in configuring the settlement system 102 to perform settlement operations are illustrated in FIG. 3. In this regard, the operations may be implemented via instruction code stored in non-transitory computer readable media 127 that resides within the subsystems configured to cause the respective subsystems to perform the operations illustrated in the figures and discussed herein.

At block 300, the settlement system 102 may receive settlement information from the administrative terminal 106. In this regard, the I/O subsystem 110 of the settlement system 102 may communicate a webpage to the administrative terminal 106 to allow an administrator to specify the settlement information.

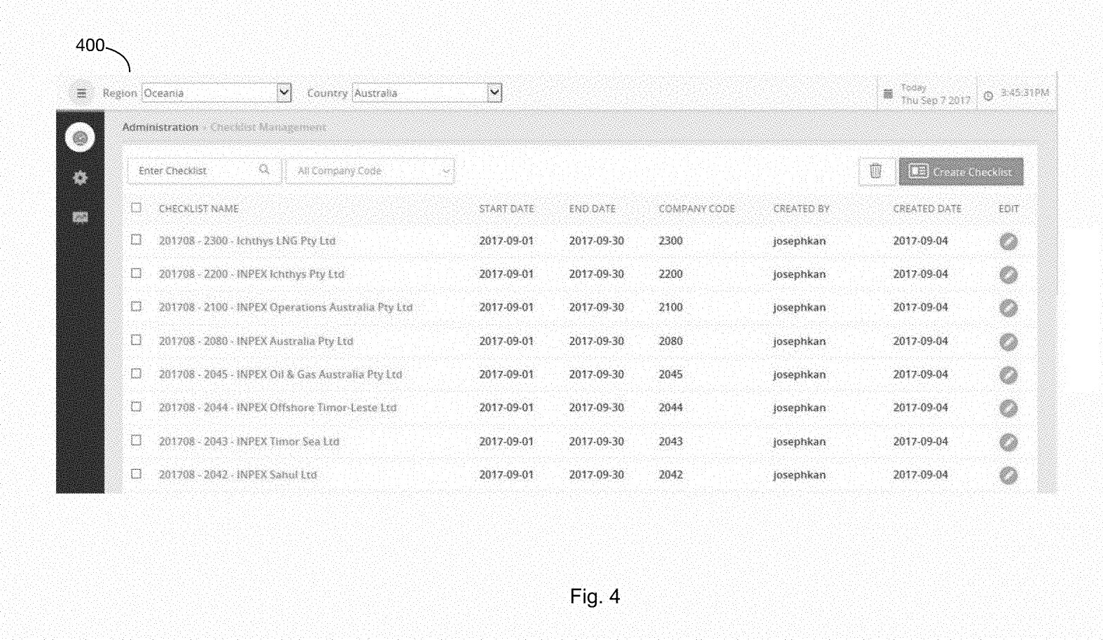

FIG. 4 illustrates an exemplary checklist management webpage 400 that may be communicated to the administrative terminal 106. Referring to FIG. 4, the checklist management webpage 400 may include columns for specifying checklist information that includes a checklist name, start date, end date, company code, created by value, and created date value. The checklist name is an identifier provided by the administrator. The start and end dates define the period over which settlement will occur. These dates will be used later in selecting transactions from the GL and JVA for settlement. The company code corresponds to a unique identifier associated with a company. The created by value identifies the administrator that specified the checklist information and the create date value corresponds to the date the checklist information was specified.

At block 305, the settlement system 102 may receive group code mapping information from the administrative terminal 106. In this regard, the I/O subsystem 110 of the settlement system 102 may communicate a webpage to the administrative terminal 106 to allow an administrator to specify the group code mapping information.

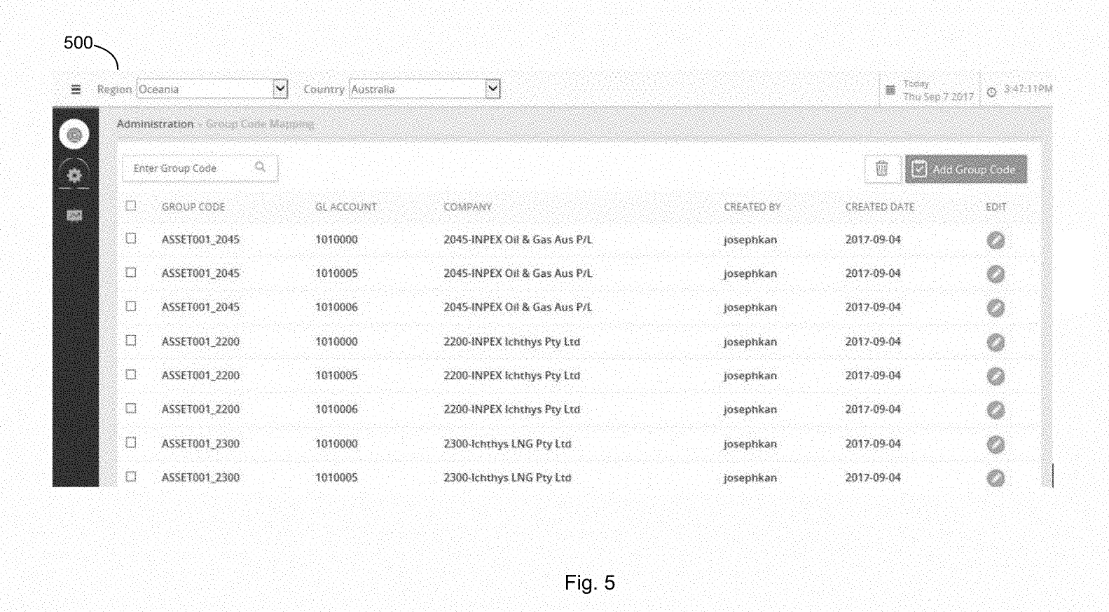

FIG. 5 illustrates an exemplary group code mapping webpage 500 that may be communicated to the administrative terminal 106. Referring to FIG. 5, the group code mapping webpage 500 may include columns for specifying a group code, GL account, company name, created by value, and created date value. The group code uniquely associates GL and JVA accounts of companies and joint ventures of the companies that are structurally related to one another. The code may be specified by the administrator or may be determined automatically using machine learning techniques. For example, the AI subsystem 115 may utilize historical trends to automatically make this determination.

Tables 1 and 2 illustrate exemplary historical trends that may have been captured in a first and second month, respectively, based on information provided by an administrator.

TABLE 1

| Company Code | GL Account | Group Code |
|---|---|---|
| 2000 | 1011000 | ASSET002 |
| 2000 | 1011005 | ASSET002 |
| 2000 | 1011006 | ASSET002 |
| 2000 | 1012100 | ASSET003 |
| 2000 | 1012101 | ASSET003 |
| 2000 | 1012105 | ASSET003 |
| 2000 | 1012106 | ASSET003 |
| 2000 | 1014000 | ASSET006 |
| 2000 | 1014001 | ASSET006 |
| 2000 | 1014005 | ASSET006 |
| 2000 | 1014006 | ASSET006 |
| 2000 | 1030001 | ASSET009 |

TABLE 2

| Company Code | GL Account | Group Code |
|---|---|---|
| 2000 | 1011000 | ASSET002 |
| 2000 | 1011005 | ASSET002 |
| 2000 | 1011006 | ASSET002 |
| 2000 | 1012100 | ASSET003 |
| 2000 | 1012101 | ASSET003 |
| 2000 | 1012105 | ASSET003 |
| 2000 | 1012106 | ASSET003 |
| 2000 | 1014000 | ASSET006 |
| 2000 | 1014001 | ASSET006 |
| 2000 | 1014005 | ASSET006 |
| 2000 | 1014006 | ASSET006 |
| 2000 | 1030001 | ASSET009 |

In the third month, the AI subsystem 115 may automatically suggest that company code 2000, with GL Account 1011000 may be mapped to ASSET002 and company code 2000, with GL Account 1030001 may be mapped to ASSET009. In general, the group code will remain same until the settlement process is completed.

The created by value identifies the administrator that specified the checklist information, and the created date value corresponds to the date the checklist information was specified.

At block 310, the settlement system 102 may receive task management information from the administrative terminal 106. In this regard, the I/O subsystem 110 of the settlement system 102 may communicate a webpage to the administrative terminal 106 to allow an administrator to specify the task management information.

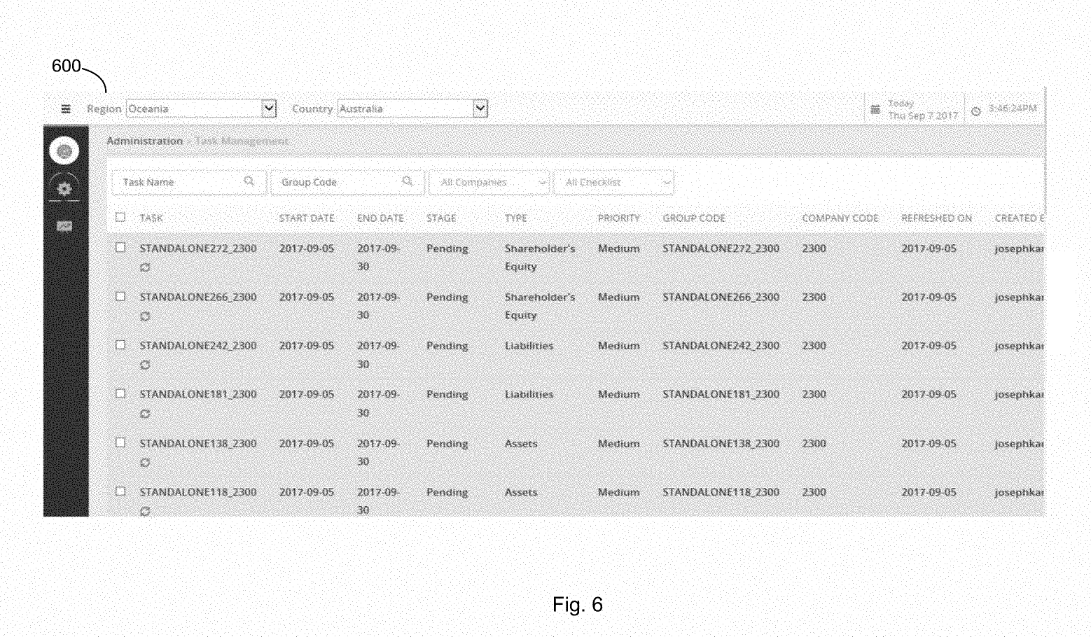

FIG. 6 illustrates an exemplary task management webpage 600 that may be communicated to the administrative terminal 106. Referring to FIG. 6, the task management webpage 400 may include columns for specifying a task name, start date, end date, stage, type, priority, group code, company code, refreshed on value, and created by value. Other fields may be provided.

Each group settlement is listed as an individual task and is mapped to a specific checklist. The number of tasks indicate the settlements to be performed for a specific period, and each task item contains all essential information of the GL accounts like currency, type, frequency, etc. Tasks can be replicated across different periods using a copy feature of the interface 600. Each task is assigned to a workflow consisting of a preparer, reviewer and approver as indicated by a client defined settlement policy and segregation of responsibilities.

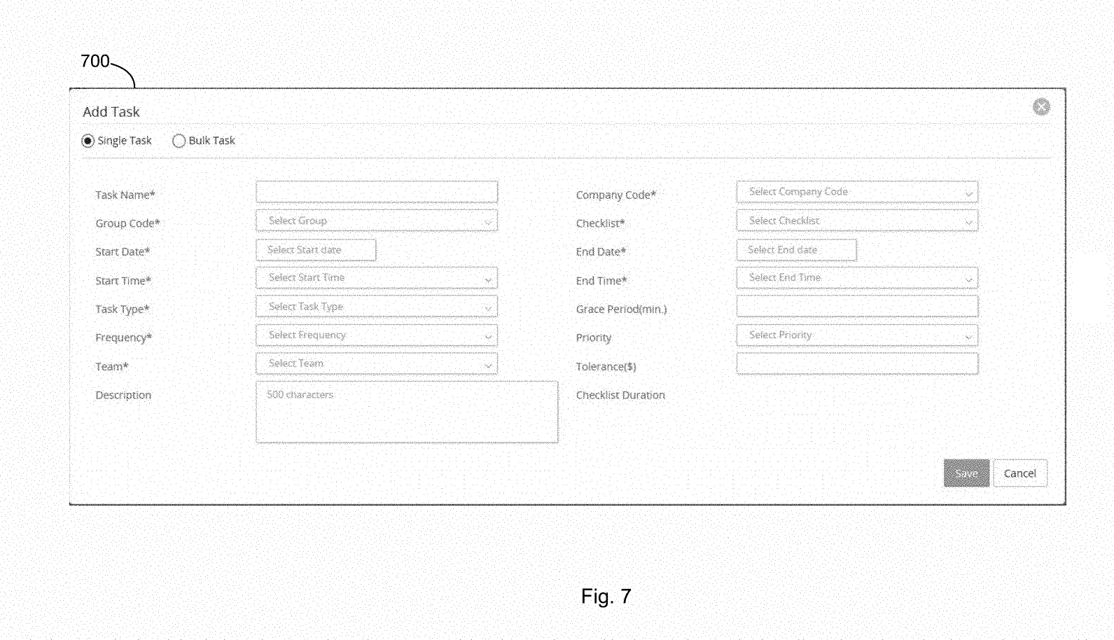

FIG. 7 illustrates an interface 700 that may be generated to facilitate entering the task information. For example, a task name field is provided to facilitate entry of a unique task name by the administrator. A group code selection field is provided to allow the administrator to associate one of the group codes listed on the group code mapping webpage 500 of FIG. 5 with the task. The checklist selection field is provided to allow the administrator to associate one of the checklist names listed on checklist management webpage 400 of FIG. 4 with the task. Other fields for specifying start/end dates and times to control when the task will run are provided.

A tolerance field may be provided to allow the administrator to associate the task with a tolerance value. The tolerance value corresponds to the minimum difference between GL and JVA accounts at which the accounts will be considered settled. For example, a tolerance value of $1 may be used to indicate that the GL and JVA accounts are considered by the settlement system 102 to be settled when the values of the GL and JVA accounts are within $1 of each. Other fields for providing other information may be provided.

Fields for designating reviewers may be provided. As described below, the settlement system 102 may communicate reports regarding settlement activities to the reviewers.

After the task information has been entered, the settlement system 102 may proceed to periodically poll the task information to determine whether it is time to execute a given task, and/or update the status of an executing task.

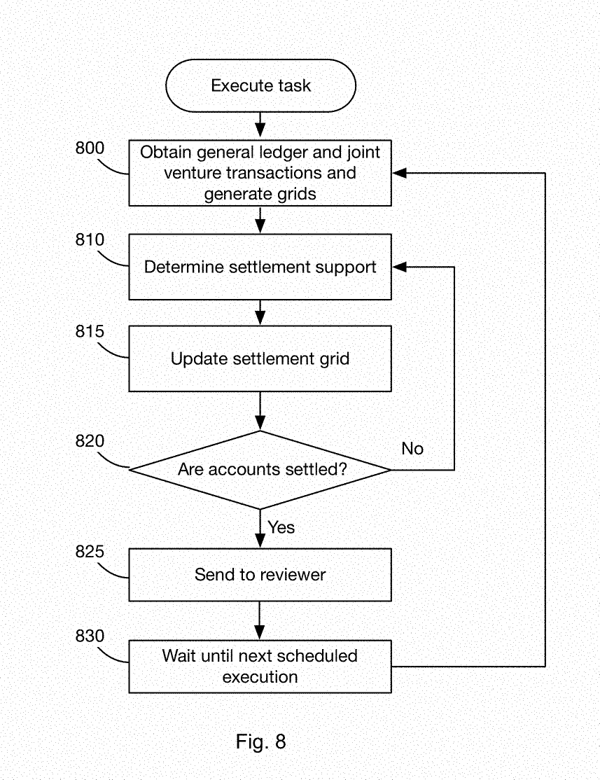

FIG. 8 illustrates various operations performed by the settlement system 102 when executing a task. Referring to FIG. 8, at block 800, general ledger and joint venture transactions may be obtained, and various webpages/interfaces to convey information associated with the transactions may be generated. The general ledger and joint venture transactions may be communicated from the JVA and FI modules 205 and 210 of the ERP subsystem 202 of each company. In this regard, the settlement system 102 may generate and communicate a request for the information to the various ERP subsystems 202. The request may specify account numbers for which transactions are required, a date range the transactions should fall within, and/or other information to control the selection of transactions. The transactions may be communicated via the network 107 via a protocol such as SFTP (secure file transport protocol). The transactions may be communicated using a different methodology.

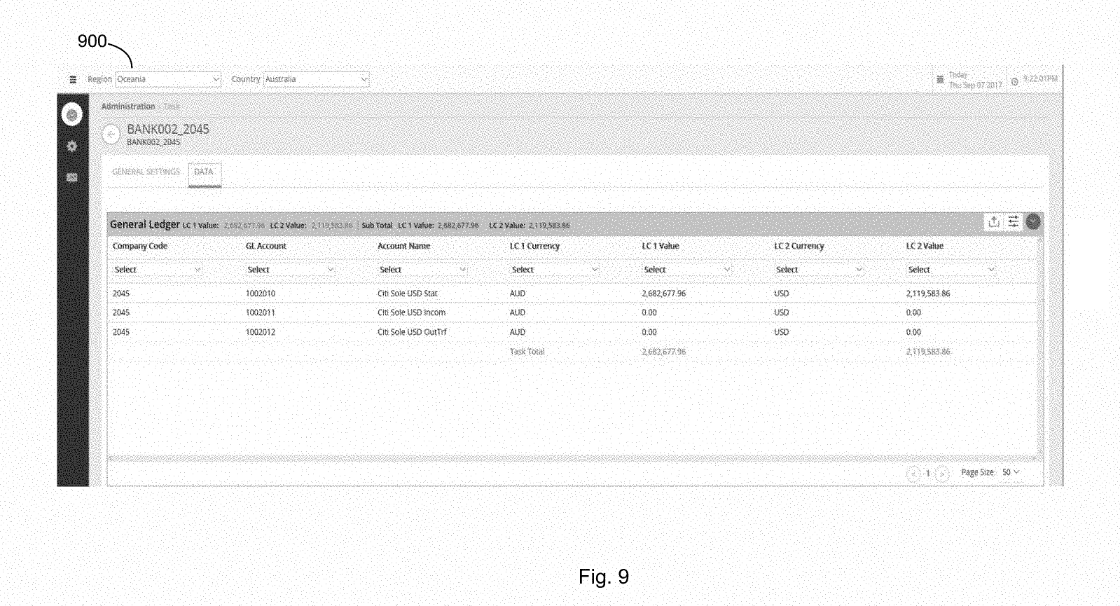

Referring to FIG. 9, a general ledger interface 900 may be generated by the settlement system 102 to convey general ledger transaction information associated with companies that are in turn associated with the group code that was specified for the current task. The interface 900 may list the company code for each company that belongs to the group, the general ledger account numbers for each general ledger account associated with each company in the group. Other information may include an account name previously associated with the GL account number,along with the value of the account in one or more specified currencies such as Australian dollars, U.S. dollars, etc.

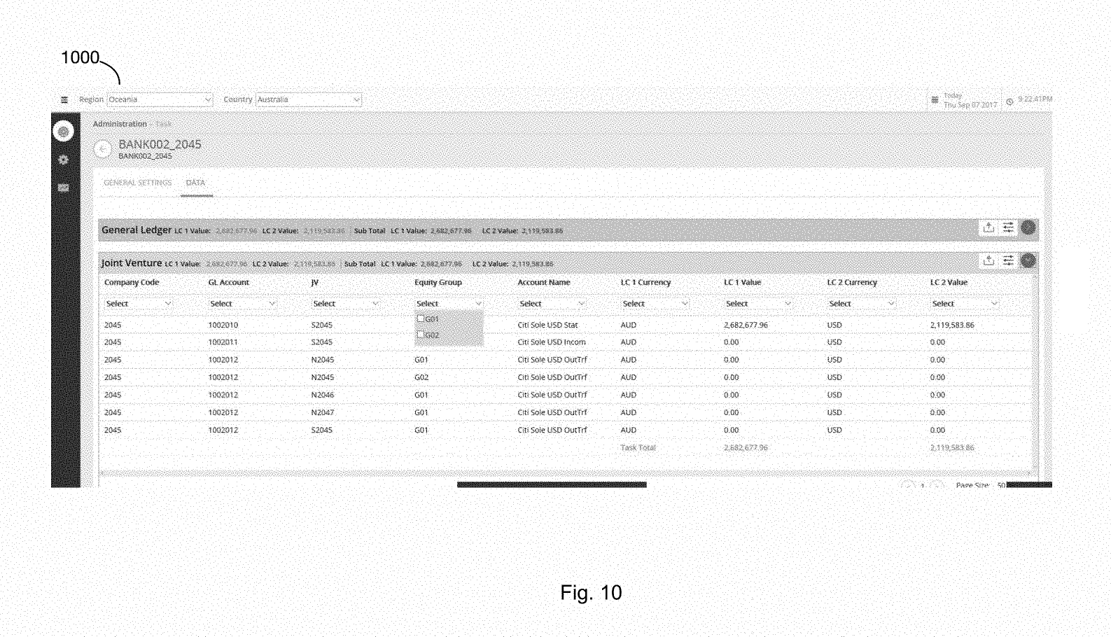

Referring to FIG. 10, a joint venture account interface 1000 may be generated by the settlement system 102 to convey joint venture account information associated with companies that are in turn associated with the group code that was specified for the current task. The interface 1000 may list the company code for each company and each joint venture company that belongs to the group, the general ledger account numbers for each general ledger account associated with each company in the group, etc. Other information may include an account name previously associated with the GL account number, along with the value of the account in one or more specified currencies such as Australian dollars, U.S. dollars, etc.

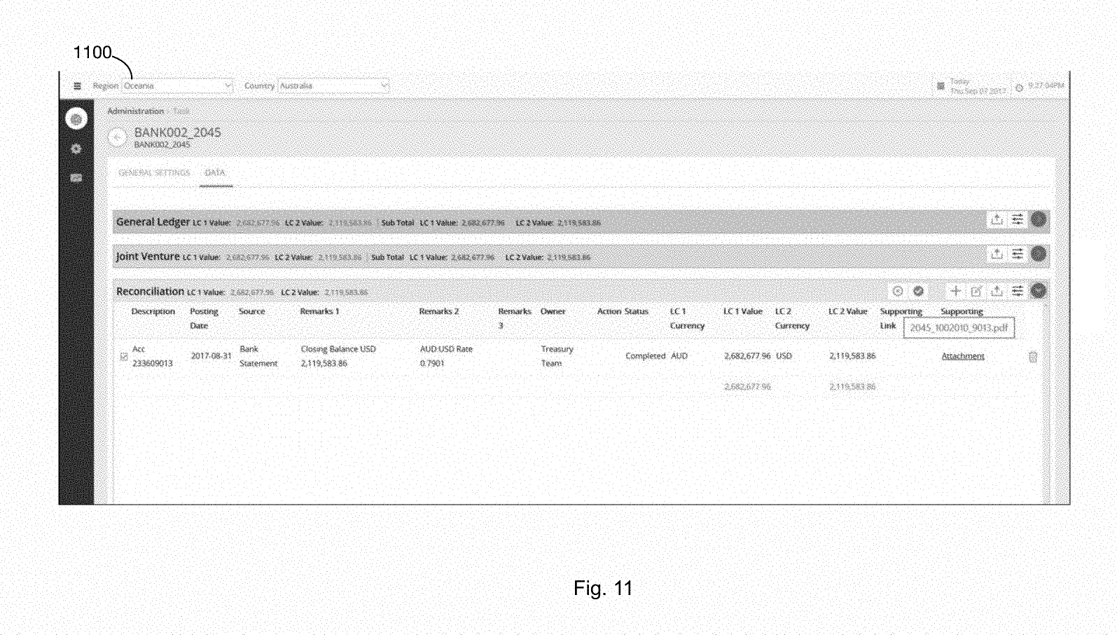

Referring to FIG. 11, a settlement interface 1100 is provided to facilitate providing support documents to support transactions associated with the general ledger and joint venture accounts. Each document may provide support for one or more transactions of the respective accounts. For example, an email from an officer of a company may indicate an amount of money that was spent by a joint venture company in purchasing certain assets. The money amount, along with various remarks associated with the document, may be specified.

At block 810, support documents may be located. For example, the AI subsystem 115 of the settlement system 102 may analyze documents in the DMS 215 of each company of the group to determine whether the document has information pertaining to a transaction in one or both of the general ledger and joint venture interfaces. In this regard, the AI subsystem 115 may utilize various natural language processing techniques to locate documentation that may relate to a given transaction. For example, the language processing may perform a Knuth-Morris-Pratt string searching algorithm to located occurrences of a words within a document that related to transactions for the various accounts. Linear clustering algorithms may be utilized to mine text data based on group codes (described below) and associated GL and JVA accounts.

At block 815, information in the documents located by the AI subsystem 115 may be extracted, and the settlement interface 1100 may be populated with the extracted information. For example, general ledger and joint venture account numbers may be detected and extracted from the documents. Currency amounts specified in the documents that may be associated with the account numbers may be extracted.

At block 820, a determination is made as to whether the accounts are settled. Settlement is determined when the total amounts on the general ledger interface 900, joint venture account interface 1000, and settlement interface 1100 come to within the tolerance value specified during creation of the task. For example, settlement of the accounts may be determined when the amounts on the respective interfaces are within $1 of each other.

If at block 820, the accounts are not settled, the operations may repeat from operation 810. That is, additional support documents may be required to support the transactions in the general ledger and joint venture account interfaces.

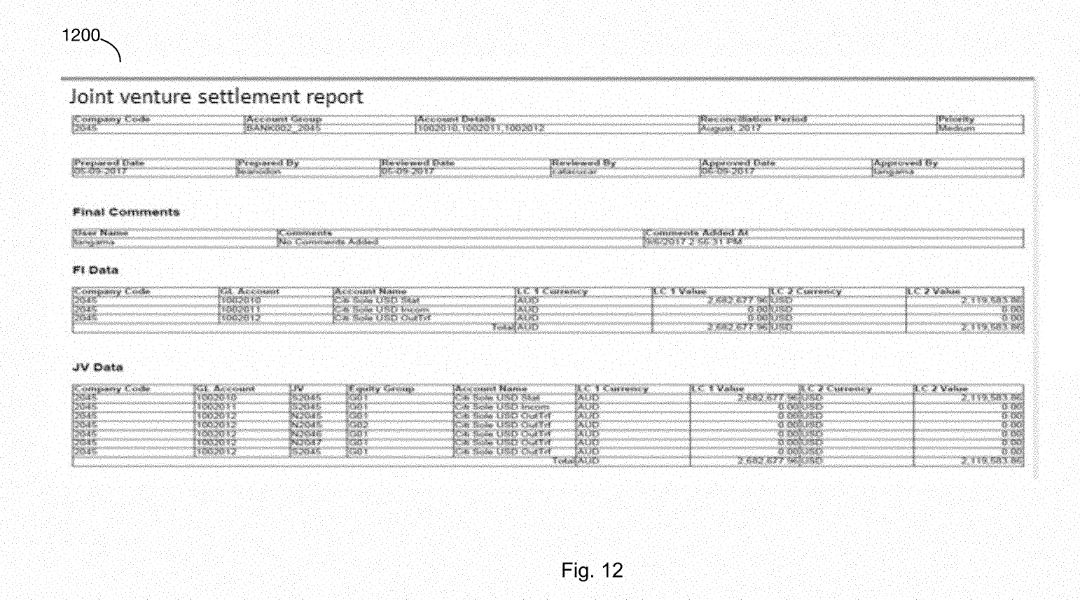

If at block 820, the accounts are determined to be settled, then at block 825, the task may be entered into a pending review state and various report documents may be communicated to one or more reviewer terminal(s) 108 to facilitate review of the reports by designated reviewers. The designated reviewers may have been specified at the time of task creation. An exemplary report that may be communicated to the reviewers is in FIG. 12.

If the reviewer(s) determine the report to be in order, the reviewer(s) may, via the reviewer terminal(s) 108, communicate instructions to the settlement system 102 to update the status of the task to complete.

At block 830, the task may remain in a dormant state until a future time that was specified during the task creation. For example, the task may have been configured to run on a quarterly schedule in which case the task will begin execution at of the operations from block 800 at the start of the next quarterly cycle.

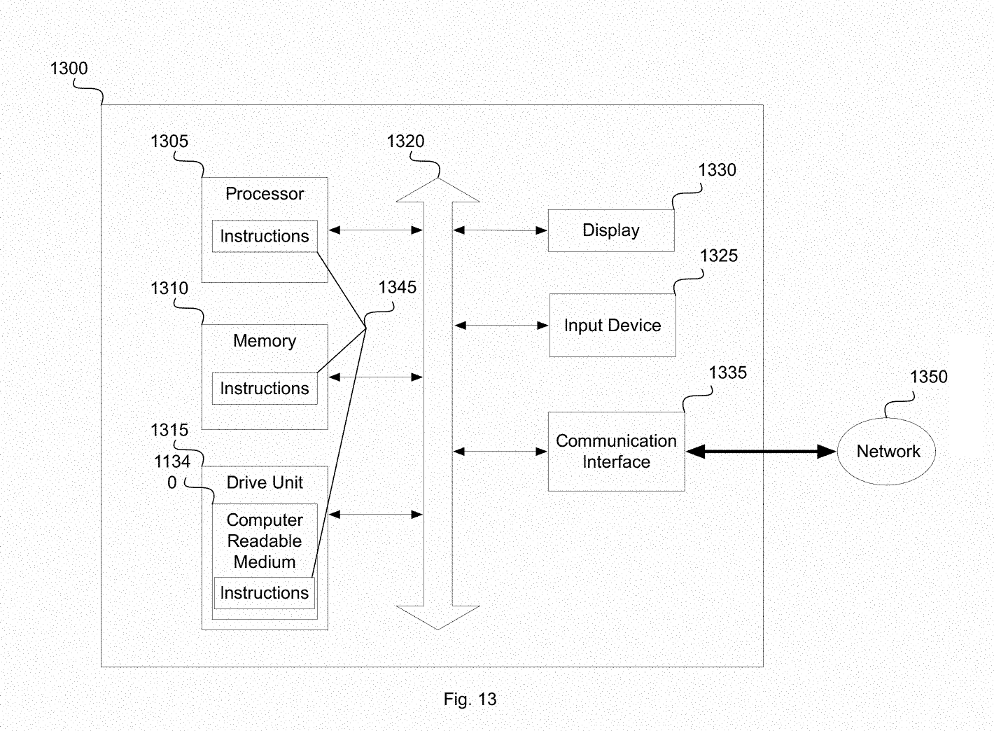

FIG. 13 illustrates a computer system 1300 that may form part of or implement the systems, environments, devices, etc., described above. The computer system 1300 may include a set of instructions 1345 that the processor 1305 may execute to cause the computer system 1300 to perform any of the operations described above. The computer system 1300 may operate as a stand-alone device or may be connected, e.g., using a network, to other computer systems or peripheral devices.

In a networked deployment, the computer system 1300 may operate in the capacity of a server or as a client computer in a server-client network environment, or as a peer computer system in a peer-to-peer (or distributed) environment. The computer system 1300 may also be implemented as or incorporated into various devices, such as a personal computer or a mobile device, capable of executing instructions 1345 (sequential or otherwise) causing a device to perform one or more actions. Further, each of the systems described may include a collection of subsystems that individually or jointly execute a set, or multiple sets, of instructions to perform one or more computer operations.

The computer system 1300 may include one or more memory devices 1310 communicatively coupled to a bus 1320 for communicating information. In addition, code operable to cause the computer system to perform operations described above may be stored in the memory 1310. The memory 1310 may be a random-access memory, read-only memory, programmable memory, hard disk drive or any other type of memory or storage device.

The computer system 1300 may include a display 1330, such as a liquid crystal display (LCD), a cathode ray tube (CRT), or any other display suitable for conveying information. The display 1330 may act as an interface for the user to see processing results produced by processor 1305.

Additionally, the computer system 1300 may include an input device 1325, such as a keyboard or mouse or touchscreen, configured to allow a user to interact with components of system 1300.

The computer system 1300 may also include a disk or optical drive unit 1315. The drive unit 1315 may include a computer-readable medium 1340 in which the instructions 1345 may be stored. The instructions 1345 may reside completely, or at least partially, within the memory 1310 and/or within the processor 1305 during execution by the computer system 1300. The memory 1310 and the processor 1305 also may include computer-readable media as discussed above.

The computer system 1300 may include a communication interface 1335 to support communications via a network 1350. The network 1350 may include wired networks, wireless networks, or combinations thereof. The communication interface 1335 may enable communications via any number of communication standards, such as 802.11, 802.12, 802.20, WiMAX, cellular telephone standards, or other communication standards.

Accordingly, methods and systems described herein may be realized in hardware, software, or a combination of hardware and software. The methods and systems may be realized in a centralized fashion in at least one computer system or in a distributed fashion where different elements are spread across interconnected computer systems. Any kind of computer system or other apparatus adapted for carrying out the methods described herein may be employed.

The methods and systems described herein may also be embedded in a computer program product, which includes all the features enabling the implementation of the operations described herein and which, when loaded in a computer system, is able to carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation and b) reproduction of a first language, code, or notation.

While methods and systems have been described with reference to certain embodiments, it will be understood by those skilled in the art that various changes may be made and equivalents may be substituted without departing from the scope of the claims. Therefore, it is intended that the present methods and systems not be limited to the particular embodiment disclosed, but that the disclosed methods and systems include all embodiments falling within the scope of the appended claims.

We claim:

1. A system for reconciling transactions comprising:
an interface that receives information related to a plurality of organizations, wherein each of the plurality of organizations includes an enterprise resource planning (ERP) system for maintaining account information associated with the organization, and a document management system (DMS) for maintaining documents for the organization;
a processor; and
non-transitory computer readable media in communication with the processor that stores instruction code which, when executed by the processor, causes the processor to:
determine, based on the information, a group of organizations of the plurality of organizations that are structurally related to one another;
for each group of organizations:
a) communicate a request to an associated enterprise planning system for information related to an account to thereby obtain an account balance for the organization;
b) communicate a request to an associated DMS for documents;
c) perform natural language processing techniques on the documents to thereby determine support documents that support transactions related to the account;
d) accumulate transaction amounts specified in the support documents;
e) when a sum of the transaction amounts is within a predetermined threshold of the account balance, determine the account to be reconciled; and
f) generate a report that specifies the account balance and the support documents.

2. The system according to claim 1, wherein the information related to a plurality of organizations defines a fiscal period, wherein the system repeats performance of steps (a)-(f) every fiscal period.

3. The system according to claim 1, wherein at least one of the group of organizations is a joint venture partly owned by another organization of the group of organizations.

4. The system according to claim 1, wherein the account corresponds to one or both of a general ledger account and a joint venture account.

5. The system according to claim 1, wherein the ERP system corresponds to an SAP ERP system that includes an FI module and a JVA module.

6. The system according to claim 1, wherein performance of natural language processing techniques includes searching for occurrences of words within a document indicative of account numbers and transaction amounts associated with the account numbers.

7. The system according to claim 6, further comprising performance of a Knuth-Morris-Pratt string searching algorithm to identify the occurrences of words within a document indicative of account numbers and transaction amounts associated with the account numbers.

8. A method for reconciling transactions comprising:
receiving information related to a plurality of organizations, wherein each of the plurality of organizations includes an enterprise resource planning (ERP) system for maintaining account information associated with the organization, and a document management system (DMS) for maintaining documents for the organization;
determining, based on the information, a group of organizations of the plurality of organizations that are structurally related to one another;
for each group of organizations:
a) communicating a request to an associated enterprise planning system for information related to an account to thereby obtain an account balance for the organization;
b) communicating a request to an associated DMS for documents;
c) performing natural language processing techniques on the documents to thereby determine support documents that support transactions related to the account;
d) accumulating transaction amounts specified in the support documents;
e) when a sum of the transaction amounts is within a predetermined threshold of the account balance, determining the account to be reconciled; and
f) generating a report that specifies the account balance and the support documents.

9. The method according to claim 8, wherein the information related to a plurality of organizations defines a fiscal period, wherein the system repeats performance of steps (a)-(f) every fiscal period.

10. The method according to claim 8, wherein at least one of the group of organizations is a joint venture partly owned by another organization of the group of organizations.

11. The method according to claim 8, wherein the account corresponds to one or both of a general ledger account and a joint venture account.

12. The method according to claim 8, wherein the ERP system corresponds to an SAP ERP system that includes an FI module and a JVA module.

13. The method according to claim 8, wherein performing of natural language processing techniques includes searching for occurrences of words within a document indicative of account numbers and transaction amounts associated with the account numbers.

14. The method according to claim 13, further comprising performing a Knuth-Morris-Pratt string searching algorithm to identify the occurrences of words within a document indicative of account numbers and transaction amounts associated with the account numbers.

15. A non-transitory computer readable medium that includes instruction code for reconciling transactions, comprising the instruction code being executable by a machine for causing the machine to perform acts including:
receiving information related to a plurality of organizations, wherein each of the plurality of organizations includes an enterprise resource planning (ERP) system for maintaining account information associated with the organization, and a document management system (DMS) for maintaining documents for the organization;
determining, based on the information, a group of organizations of the plurality of organizations that are structurally related to one another;
for each group of organizations:
a) communicating a request to an associated enterprise planning system for information related to an account to thereby obtain an account balance for the organization;
b) communicating a request to an associated DMS for documents;
c) performing natural language processing techniques on the documents to thereby determine support documents that support transactions related to the account;
d) accumulating transaction amounts specified in the support documents;
e) when a sum of the transaction amounts is within a predetermined threshold of the account balance, determining the account to be reconciled; and
f) generating a report that specifies the account balance and the support documents.

16. The non-transitory computer readable according to claim 15, wherein the information related to a plurality of organizations defines a fiscal period, wherein the system repeats performance of steps (a)-(f) every fiscal period.

17. The non-transitory computer readable according to claim 15, wherein at least one of the group of organizations is a joint venture partly owned by another organization of the group of organizations.

18. The non-transitory computer readable according to claim 15, wherein the account corresponds to one or both of a general ledger account and a joint venture account.

19. The non-transitory computer readable according to claim 15, wherein the ERP system corresponds to an SAP ERP system that includes an FI module and a JVA module.

20. The non-transitory computer readable according to claim 15, wherein the instruction code causes the machine to perform natural language processing techniques that include searching for occurrences of words within a document indicative of account numbers and transaction amounts associated with the account numbers.
